(19) United States
(12) Patent Application Publication
(10) Pub. No.: US 2013/0324626 A1
(43) Pub. Date: Dec. 5, 2013

(54) PRODUCING RIGID POLYURETHANE FOAMS

(71) Applicant: BASF SE, Ludwigshafen (DE)

(72) Inventors: Roland FABISIAK, Brockum (DE); Gunnar Kampf, Stemwede-Haldem (DE); Lars Schoen, Osnabrueck (DE); Olaf Jacobmeier, Luebbecke (DE)

(73) Assignee: BASF SE, Ludwigshafen (DE)

(21) Appl. No.: 13/897,690

(22) Filed: May 20, 2013

Related U.S. Application Data
(60) Provisional application No. 61/652,892, filed on May 30, 2012.

(51) Int. Cl. C08J 9/00

(52) U.S. Cl. CPC C08J 9/0038
USPC 521/108; 521/107; 252/609

(57) ABSTRACT

The invention relates to a process for producing rigid polyurethane foams by reaction of
A) one or more organic polyisocyanates,
B) one or more polyester polyols,
C) optionally one or more polyether polyols,
D) a flame-retardant mixture,
E) further auxiliaries or addition agents,
F) one or more blowing agents, and also
G) catalysts,
   wherein said flame-retardant mixture D) comprises
d1) 10 to 90 wt %, based on the amount of flame-retardant mixture, of a flame retardant having a boiling point of not more than 220° C., and
d2) 10 to 90 wt %, based on the amount of flame-retardant mixture, of a phosphorus-containing flame retardant having a boiling point of above 220° C.,
   wherein said components d1) and d2) total 100 wt %.

The present invention relates to a process for producing rigid polyurethane foams. The present invention also relates to the thus obtainable rigid foams themselves and also to their use for production of sandwich elements having rigid or flexible outer layers. The present invention further relates to the polyol component used for producing the rigid polyurethane foams.

Producing rigid polyurethane foams by reacting organic or modified organic di- or polyisocyanates with relatively high molecular weight compounds having at least two reactive hydrogen atoms, especially with polyether polyols from alkylene oxide polymerization or polyester polyols from condensation polymerization of alcohols with dicarboxylic acids in the presence of polyurethane catalysts, chain-extending and/or crosslinking agents, blowing agents and further auxiliary and addition agents is known and is described in numerous patent and literature publications. WO 2007/025888 for example describes producing rigid polyurethane foams.

Rigid polyurethane foams frequently display a high degree of brittleness on cutting to size with severe evolution of dust and high sensitivity on the part of the foams. This can lead to cracking in the foam on sawing, especially in composite elements with metallic outer layers and a core of polyisocyanurate foam. At higher mixing ratios, the brittleness of polyisocyanurate (PIR) foams and hence the cracking tendency increase.

A further disadvantage of polyester polyols based on aromatic carboxylic acids or aromatic carboxylic acid derivatives such as terephthalic acid or phthalic anhydride is often their high viscosity, since it makes the mixing with the isocyanate component distinctly more difficult.

In addition, problems with unsatisfactory dimensional stability, i.e., the foam product distorts significantly after removal from the mold or after the pressure section when processed by the double belt process, can occur in certain systems for producing rigid PU foams, for example when using glycerol as relatively high-functionality alcoholic polyester component.

The problem of the behavior of rigid PU foams in the event of a fire has hitherto also not been satisfactorily solved for all systems. For example, a toxic compound can form in the event of a fire when using trimethylolpropane (TMP) as relatively high-functionality alcoholic polyester component.

A general problem in the production of rigid foams is the formation of surface defects, particularly at the interface with metallic outer layers. These foam surface defects cause formation of an uneven metal surface in sandwich elements and thus often lead to visual unacceptability of the product. An improvement in the foam surface reduces the frequency of the occurrence of such surface defects and thus leads to a visual improvement in the surface of sandwich elements.

It is further generally desirable to provide systems having a very high self-reactivity in order that the use of catalysts may be minimized.

The invention has for its object to provide a polyol component that has a high self-reactivity. The present invention further has for its object to provide rigid PU foams of low brittleness which are not prone to cracking when composite elements are sawn. In addition, the rigid PU foams shall display improved curing characteristics.

The components used and the blends produced therefrom shall further be of low viscosity in order to be readily meterable and mixable in the production of rigid PU foams. Furthermore, the solubility of blowing agents, as for example the solubility of pentane in the polyol component, shall be very good.

The invention further has for its object to improve the dimensional stability of rigid PU foams. The formation of toxic compounds in the event of fire shall be very low. Furthermore, the formation of surface defects shall be reduced.

We have found that this object is achieved by a process for producing rigid polyurethane foams by reaction of

A) one or more organic polyisocyanates,
B) one or more polyester polyols,
C) optionally one or more polyether polyols,
D) a flame-retardant mixture,
E) further auxiliaries or addition agents,
F) one or more blowing agents, and also
G) catalysts,
wherein said flame-retardant mixture D) comprises
d1) 10 to 90 wt %, based on the amount of flame-retardant mixture, of a flame retardant having a boiling point of not more than 220° C., and
d2) 10 to 90 wt %, based on the amount of flame-retardant mixture, of a phosphorus-containing flame retardant having a boiling point of above 220° C.,
   wherein said components d1) and d2) total 100 wt %.

The present invention also provides a polyol component comprising the aforementioned components B) to G). In general, the mass ratio of polyester polyol component B) to polyether polyol component C) is at least 1.

The present invention further provides rigid polyurethane foams obtainable by the process of the present invention and also their use for production of sandwich elements having rigid or flexible outer layers. Rigid polyurethane foams also subsume rigid polyisocyanurate foams. These are specific forms of rigid polyurethane foams.

The invention will now be more particularly elucidated.

### Component B

In the context of the present disclosure, the terms “polyester polyol” and “polyesterol” are interchangeable, as are the terms “polyether polyol” and “polyetherol”.

Useful polyester polyols B) are obtainable for example from dicarboxylic acids having 2 to 12 carbon atoms, preferably aromatic dicarboxylic acids or mixtures of aromatic and aliphatic dicarboxylic acids and polyhydric alcohols, preferably diols, having 2 to 12 carbon atoms, preferably 2 to 6 carbon atoms.

Possible dicarboxylic acids are in particular: succinic acid, glutaric acid, adipic acid, suberic acid, azelaic acid, sebacic acid, decanedicarboxylic acid, maleic acid, fumaric acid, phthalic acid, isophthalic acid and terephthalic acid. The dicarboxylic acids can be used either individually or in admixture with one another. It is also possible to use the derivatives of these dicarboxylic acids, such as for example dimethyl terephthalate. It is also possible to use the corresponding dicarboxylic acid derivatives, e.g. dicarboxylic esters of alcohols having from 1 to 4 carbon atoms or dicarboxylic anhydrides, in place of the free dicarboxylic acids. As aromatic dicarboxylic acids, preference is given to using phthalic acid, phthalic anhydride, terephthalic acid and/or isophthalic acid as a mixture or alone. As aliphatic dicarboxylic acids, preference is given to using dicarboxylic acid mixtures of succinic, glutaric and adipic acid in weight ratios of, for example, 20-35:35-50:20-32 parts by weight and in particular adipic acid. Examples of dihydric and polyhydric alcohols, in particular diols, are: ethanediol, diethylene glycol, 1,2- or 1,3-propanediol, dipropylene glycol, 1,4-butanediol, 1,5-pentanediol, 1,6-hexanediol, 1,10-decanediol, glycerol, trimethylolpropane and pentaerythritol. Preference is given to using ethanediol, diethylene glycol, 1,4-butanediol, 1,5-pentanediol, 1,6-hexanediol or mixtures of at least two of the diols mentioned, in particular mixtures of 1,4-butanediol, 1,5-pentanediol and 1,6-hexanediol. It is also possible to use polyester polyols derived from lactones, e.g. ε-caprolactone, or hydroxycarboxylic acids, e.g. w-hydroxycaproic acid.

To prepare the further polyester polyols B), bio-based starting materials and/or derivatives thereof are also suitable, for example, castor oil, polyhydroxy fatty acids, ricinoleic acid, hydroxyl-modified oils, grapeseed oil, black cumin oil, pumpkin kernel oil, borage seed oil, soybean oil, wheat germ oil, rapeseed oil, sunflower oil, peanut oil, apricot kernel oil, pistachio oil, almond oil, olive oil, macadamia nut oil, avocado oil, sea buckthorn oil, sesame oil, hemp oil, hazelnut oil, primula oil, wild rose oil, safflower oil, walnut oil, fatty acids, hydroxyl-modified fatty acids and fatty acid esters based on myristoleic acid, palmitoleic acid, oleic acid, vaccenic acid, petroselic acid, gadoleic acid, erucic acid, nervonic acid, linoleic acid, α- and γ-linolenic acid, stearidonic acid, arachidonic acid, timnodonic acid, clupanodonic acid and cervonic acid.

Preferably, the polyester component B) comprises at least one polyetherester polyol comprising the esterification product of
b1) 10 to 70 mol % of a dicarboxylic acid composition comprising
b11) 50 to 100 mol %, based on the dicarboxylic acid composition, of one or more aromatic dicarboxylic acids or derivatives thereof,
b12) 0 to 50 mol %, based on said dicarboxylic acid composition b1), of one or more aliphatic dicarboxylic acids or derivatives thereof,
b2) 2 to 30 mol % of one or more fatty acids and/or fatty acid derivatives,
b3) 10 to 70 mol % of one or more aliphatic or cycloaliphatic diols having 2 to 18 carbon atoms or alkoxylates thereof,
b4) 2 to 50 mol % of a polyether polyol having a functionality of not less than 2, prepared by alkoxylating a polyol having a functionality of not less than 2,
   all based on the total amount of components b1) to b4), wherein said components b1) to b4) sum to 100 mol %.

Preferably, the component b11) comprises at least one compound selected from the group consisting of terephthalic acid, dimethyl terephthalate (DMT), polyethylene terephthalate (PET), phthalic acid, phthalic anhydride (PA) and isophthalic acid. More preferably, the component b11) comprises at least one compound from the group consisting of terephthalic acid, dimethyl terephthalate (DMT), polyethylene terephthalate (PET) and phthalic anhydride (PA). Even more preferably, the component b11) comprises phthalic anhydride, dimethyl terephthalate, terephthalic acid or mixtures thereof. The aromatic dicarboxylic acids or their derivatives of component b11) are more preferably selected from the aforementioned aromatic dicarboxylic acids, and dicarboxylic acid derivatives, respectively, and specifically from terephthalic acid and/or dimethyl terephthalate (DMT). Terephthalic acid and/or DMT in component b11) leads to polyetherester polyols B) having particularly good fire protection properties.

The proportion in which aliphatic dicarboxylic acids or dicarboxylic acid derivatives (component b12)) are comprised in the dicarboxylic acid composition b1) is generally in the range from 0 to 30 mol % and preferably in the range from 0 to 10 mol %. It is particularly preferable for the dicarboxylic acid composition b1) to comprise no aliphatic dicarboxylic acids or derivatives thereof and thus to consist to an extent of 100 mol % of one or more aromatic dicarboxylic acids or their derivatives, in which case the aforementioned ones are preferred. Useful derivatives are generally the esters, preferably C₁₋₆-alkyl esters, especially the methyl esters of the dicarboxylic acids.

The amounts in which component b2) is used are preferably in the range from 3 to 20 mol % and more preferably in the range from 5 to 18 mol %.

The amounts in which component b3) is used are preferably in the range from 20 to 60 mol %, more preferably in the range from 25 to 55 mol % and even more preferably in the range from 30 to 45 mol %.

The amounts in which component b4) is used are preferably in the range from 2 to 40 mol %, more preferably in the range from 8 to 35 mol % and even more preferably in the range from 15 to 25 mol %.

In one preferred embodiment of the present invention, the amine catalyst for producing the component b4) is selected from the group comprising dimethylethanolamine (DMEOA), imidazole and imidazole derivatives and also mixtures thereof, more preferably imidazole.

In one embodiment of the invention, the fatty acid or fatty acid derivative b2) consists of a fatty acid or fatty acid mixture, one or more glycerol esters of fatty acids or, respectively, of fatty acid mixtures and/or one and more fatty acid monoesters, for example biodiesel or methyl esters of fatty acids, and it is particularly preferable for component b2) to consist of a fatty acid or fatty acid mixture and/or one or more fatty acid monoesters and it is more preferable for the component b2) to consist of a fatty acid or fatty acid mixture and/or biodiesel, and it is most preferable for the component b2) to consist of a fatty acid or fatty acid mixture.

In one preferred embodiment of the invention, the fatty acid or fatty acid derivative b2) is selected from the group consisting of castor oil, polyhydroxy fatty acids, ricinoleic acid, hydroxyl-modified oils, grapeseed oil, black cumin oil, pumpkin kernel oil, borage seed oil, soybean oil, wheat germ oil, rapeseed oil, sunflower oil, peanut oil, apricot kernel oil, pistachio oil, almond oil, olive oil, macadamia nut oil, avocado oil, sea buckthorn oil, sesame oil, hemp oil, hazelnut oil, primula oil, wild rose oil, safflower oil, walnut oil, animal-based tallow, for example beef tallow, fatty acids, hydroxyl-modified fatty acids and fatty acid esters based on myristoleic acid, palmitoleic acid, oleic acid, vaccenic acid, petroselic acid, gadoleic acid, erucic acid, nervonic acid, linoleic acid, α- and γ-linolenic acid, stearidonic acid, arachidonic acid, timnodonic acid, clupanodonic acid and cervonic acid.

In a further preferred embodiment of the present invention, the fatty acid or fatty acid derivative b2) is oleic acid, biodiesel, soybean oil, rapeseed oil or tallow, more preferably oleic acid, soybean oil, rapeseed or beef tallow and specifically oleic acid. The fatty acid or fatty acid derivative serves to improve inter alia the blowing agent solubility in the production of polyurethane foams. It is very particularly preferable for component b2) not to comprise any triglyceride, especially no oil or fat. The glycerol released from the triglyceride by the esterification/transesterification has a detrimental effect on rigid foam dimensional stability, as mentioned above. Preferred fatty acids and fatty acid derivatives in the context of component b2) are therefore the fatty acids themselves and also alkyl monoesters of fatty acids or alkyl monoesters of fatty acid mixtures, especially the fatty acids themselves and/or biodiesel.

Preferably the aliphatic or cycloaliphatic diol b3) is selected from the group consisting of ethylene glycol, diethylene glycol, propylene glycol, 1,3-propanediol, 1,4-butanediol, 1,5-pentanediol, 1,6-hexanediol, 2-methyl-1,3-propanediol and 3-methyl-1,5-pentane-diol and alkoxylates thereof. It is particularly preferable for the aliphatic diol b3) to be monoethylene glycol or diethylene glycol, especially diethylene glycol.

Preferably, a polyether polyol b4) is used having a functionality above 2, which was prepared by alkoxylating a polyol having a functionality of not less than 3.

In general, the polyether polyol b4) has a functionality greater than 2. It preferably has a functionality of not less than 2.7 and especially of not less than 2.9. In general, it has a functionality of not more than 6, preferably not more than 5 and more preferably not more than 4.

In one embodiment of the present invention, the polyether polyol b4) is obtainable by reacting a polyol having a functionality of greater than 2 with ethylene oxide and/or propylene oxide, preferably with ethylene oxide.

In a further preferable embodiment, the polyether polyol b4) is obtainable by alkoxylating, preferably ethoxylating, a polyol selected from the group consisting of sorbitol, pentaerythritol, trimethylolpropane, glycerol, polyglycerol and mixtures thereof, more preferably a polyol selected from the group consisting of trimethylolpropane and glycerol.

In one particularly preferable embodiment, the polyether polyol b4) is obtainable by alkoxylation with ethylene oxide, leading to rigid polyurethane foams having improved fire protection properties.

In one particularly preferred embodiment of the present invention, the component b4) is prepared by anionic polymerization of propylene oxide or ethylene oxide, preferably ethylene oxide, in the presence of alkoxylation catalysts, such as alkali metal hydroxides, such as sodium hydroxide or potassium hydroxide, or alkali metal alkoxides, such as sodium methoxide, sodium ethoxide, potassium ethoxide or potassium isopropoxide, or aminic alkoxylation catalysts, such as dimethylethanolamine (DMEOA), imidazole and imidazole derivatives and also mixtures thereof by using at least one starter molecule. KOH and aminic alkoxylation catalysts are preferred alkoxylation catalysts. Since the polyether first has to be neutralized when KOH is used as alkoxylation catalyst and the potassium salt produced has to be removed before the polyether can be used in the esterification as component b4), the use of aminic alkoxylation catalysts is preferred. Preferred aminic alkoxylation catalysts are selected from the group comprising dimethylethanolamine (DMEOA), imidazole and imidazole derivatives and also mixtures thereof, more preferably imidazole.

In one advantageous embodiment of the invention, the polyether polyol b4) consists of the reaction product of glycerol with ethylene oxide and/or propylene oxide, preferably with ethylene oxide. As a result, the storage stability of component B) is particularly high.

In a further advantageous embodiment of the invention, the polyether polyol b4) consists of the reaction product of trimethylolpropane with ethylene oxide and/or propylene oxide, preferably with ethylene oxide. Again the result is a particularly high improved storage stability for component B).

Preferably, the polyether polyol b4) has an OH number in the range from 150 to 1250 mg KOH/g, preferably in the range from 300 to 950 mg KOH/g and more preferably in the range from 500 to 800 mg KOH/g.

In a further preferred embodiment, at least 200 mmol, preferably at least 400 mmol, more preferably at least 600 mmol, even more preferably at least 800 mmol and most preferably at least 1000 mmol of component b4) are used per kg of component B).

In a particularly preferred embodiment of the invention, the polyether polyol b4) consists of the reaction product of trimethylolpropane or glycerol, preferably glycerol, with ethylene oxide, wherein the OH number of the polyether polyol b4) is in the range from 500 to 800 mg KOH/g, preferably 500 to 650 mg KOH/g, and imidazole is used as alkoxylation catalyst.

In an especially preferred embodiment of the invention, the polyether polyol b4) consists of the reaction product of trimethylolpropane or glycerol, preferably glycerol, with ethylene oxide, wherein the OH number of the polyether polyol b4) is in the range from 500 to 800 mg KOH/g, preferably 500 to 650 mg KOH/g, imidazole is used as alkoxylation catalyst, and the aliphatic or cycloaliphatic diol b3) is diethylene glycol, and the fatty acid or the fatty acid derivative b2) is oleic acid.

Preferably, the polyetherester polyol B) has a number-weighted average functionality of not less than 2, preferably of greater than 2, more preferably greater than 2.2 and especially greater than 2.3, leading to a higher crosslink density on the part of the polyurethane prepared therewith and hence to better mechanical properties on the part of the polyurethane foam.

To prepare the polyetherester polyols B), the aliphatic and aromatic polycarboxylic acids and/or derivatives and polyhydric alcohols can be polycondensed in the absence of catalysts or preferably in the presence of esterification catalysts, advantageously in an atmosphere of inert gas, e.g. nitrogen, in the melt at temperatures of from 150 to 280° C., preferably from 180 to 260° C., optionally under reduced pressure, to the desired acid number which is advantageously less than 10, preferably less than 2. In a preferred embodiment, the esterification mixture is polycondensed at the abovementioned temperatures to an acid number of from 80 to 20, preferably from 40 to 20, under atmospheric pressure and subsequently under a pressure of less than 500 mbar, preferably from 40 to 400 mbar. Possible esterification catalysts are, for example, iron, cadmium, cobalt, lead, zinc, antimony, magnesium, titanium and tin catalysts in the form of metals, metal oxides or metal salts. However, the polycondensation can also be carried out in the liquid phase in the presence of diluents and/or entrainers such as benzene, toluene, xylene or chlorobenzene in order to distill off the water of condensation as an azeotrope.

To produce the polyetherester polyols, the organic polycarboxylic acids and/or derivatives and polyhydric alcohols are advantageously polycondensed in a molar ratio of 1:1-2.2, preferably 1:1.05-2.1 and particularly preferably 1:1.1-2.0.

The polyetherester polyols obtained generally have a number average molecular weight in the range from 300 to 3000, preferably in the range from 400 to 1000 and especially in the range from 450 to 800.

The proportion of polyester polyols B) is generally at least 10 wt %, preferably at least 20 wt % and more preferably at least 40 wt % and especially preferably at least 50 wt %, based on total components B) to G).

Producing rigid polyurethane foams by the process of the present invention, in addition to the specific polyester polyols (polyetherester polyols) described above, utilizes the conventional construction components, about which the following details may be provided.

In addition to the polyetherester polyols, further polyester polyols may be present. In general, the mass ratio of polyetherester polyols to the further polyester polyols is at least 0.1, preferably at least 0.25, more preferably at least 0.5 and especially at least 0.8. In a particularly preferred embodiment, it is exclusively polyetherester polyols from components b1) to b4) which are used as component B).

### Component A

Polyisocyanate for the purposes of the present invention is to be understood to be referring to an organic compound comprising at least two reactive isocyanate groups per molecule, i.e., the functionality is at least 2. When the polyisocyanates used or a mixture of two or more polyisocyanates do not have a unitary functionality, the number-weighted average functionality of component A) used is at least 2.

The aliphatic, cycloaliphatic, araliphatic polyfunctional isocyanates known per se and preferably the aromatic polyfunctional isocyanates come into consideration for use as polyisocyanates A). Polyfunctional isocyanates of this type are known per se or are obtainable by methods known per se. Polyfunctional isocyanates may more particularly also be used as mixtures, in which case component A) will accordingly comprise various polyfunctional isocyanates. Polyfunctional isocyanates that come into consideration for use as polyisocyanate have two (hereinafter called diisocyanates) or more than two isocyanate groups per molecule.

Specific examples are: alkylene diisocyanates having from 4 to 12 carbon atoms in the alkylene radical, e.g. dodecane 1,12-diisocyanate, 2-ethyltetramethylene 1,4-diisocyanate, 2-methylpentamethylene 1,5-diisocyanate, tetramethylene 1,4-diisocyanate, and preferably hexamethylene 1,6-diisocyanate; cycloaliphatic diisocyanates such as cyclohexane 1,3- and 1,4-diisocyanate and also any mixtures of these isomers, 1-isocyanato-3,3,5-trimethyl-5-isocyanatomethylcyclohexane (IPDI), hexahydrotolylene 2,4- and 2,6-diisocyanate and also the corresponding isomer mixtures, dicyclohexylmethane 4,4′-, 2,2′- and 2,4′-diisocyanate and also the corresponding isomer mixtures and preferably aromatic polyisocyanates such as tolylene 2,4- and 2,6-diisocyanate and the corresponding isomer mixtures, diphenylmethane 4,4′-, 2,4′- and 2,2′-diisocyanate and the corresponding isomer mixtures, mixtures of diphenylmethane 4,4′- and 2,2′-diisocyanates, polyphenylpolymethylene polyisocyanates, mixtures of diphenylmethane 4,4′-, 2,4′- and 2,2′-diisocyanates and polyphenylpolymethylene polyisocyanates (crude MDI) and mixtures of crude MDI and tolylene diisocyanates.

Of particular suitability are 2,2′-, 2,4′- and/or 4,4′-diphenylmethane diisocyanate (MDI), 1,5-naphthylene diisocyanate (NDI), 2,4- and/or 2,6-tolylene diisocyanate (TDI), 3,3′-dimethylbiphenyl diisocyanate, 1,2-diphenylethane diisocyanate and/or p-phenylene diisocyanate (PPDI), tri-, tetra-, penta-, hexa-, hepta- and/or octamethylene diisocyanate, 2-methylpentamethylene 1,5-diisocyanate, 2-ethylbutylene 1,4-diisocyanate, pentamethylene 1,5-diisocyanate, butylene 1,4-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), 1,4-cyclohexane diisocyanate, 1-methyl-2,4- and/or -2,6-cyclohexane diisocyanate and 4,4′-, 2,4′- and/or 2,2′-dicyclohexylmethane diisocyanate.

Modified polyisocyanates are also frequently used, i.e., products which are obtained by chemical reaction of organic polyisocyanates and which have at least two reactive isocyanate groups per molecule. Polyisocyanates comprising ester, urea, biuret, allophanate, carbodiimide, isocyanurate, uretdione, carbamate and/or urethane groups may be mentioned in particular.

The following embodiments are particularly preferable for use as polyisocyanates of component A):
i) Polyfunctional isocyanates based on tolylene diisocyanate (TDI), especially 2,4-TDI or 2,6-TDI or mixtures of 2,4- and 2,6-TDI;
ii) Polyfunctional isocyanates based on diphenylmethane diisocyanate (MDI), especially 2,2′-MDI or 2,4′-MDI or 4,4′-MDI or oligomeric MDI, which is also known as polyphenyl polymethylene isocyanate, or mixtures of two or three of the aforementioned diphenylmethane diisocyanates, or crude MDI, which is generated in the production of MDI, or mixtures of at least one oligomer of MDI and at least one of the aforementioned low molecular weight MDI derivatives;
iii) Mixtures of at least one aromatic isocyanate of embodiment i) and at least one aromatic isocyanate of embodiment ii).

Polymeric diphenylmethane diisocyanate is very particularly preferred for use as polyisocyanate. Polymeric diphenylmethane diisocyanate (hereinafter called polymeric MDI) is a mixture of two-nuclear MDI and oligomeric condensation products and thus derivatives of diphenylmethane diisocyanate (MDI). The polyisocyanates may preferably also be constructed from mixtures of monomeric aromatic diisocyanates and polymeric MDI.

Polymeric MDI in addition to two-nuclear MDI comprises one or more polynuclear condensation products of MDI with a functionality of more than 2, especially 3 or 4 or 5. Polymeric MDI is known and is frequently referred to as polyphenyl polymethylene isocyanate or else as oligomeric MDI. Polymeric MDI is typically constructed from a mixture of MDI-based isocyanates of differing functionality. Polymeric MDI is typically used in admixture with monomeric MDI.

The (average) functionality of a polyisocyanate comprising polymeric MDI can vary in the range from about 2.2 to about 5, more particularly from 2.3 to 4, more particularly from 2.4 to 3.5. Such a mixture of MDI-based polyfunctional isocyanates having different functionalities is especially the crude MDI obtained as intermediate in the production of MDI.

Polyfunctional isocyanates or mixtures of two or more polyfunctional isocyanates based on MDI are known and are for example marketed by BASF Polyurethanes GmbH under the name of Lupranat®.

The functionality of component A) is preferably at least two, more preferably at least 2.2 and especially at least 2.4. The functionality of component A) is preferably in the range from 2.2 to 4 and more preferably in the range from 2.4 to 3.

The content of isocyanate groups in component A) is preferably in the range from 5 to 10 mmol/g, more preferably in the range from 6 to 9 mmol/g, and especially in the range from 7 to 8.5 mmol/g. A person skilled in the art knows that the content of isocyanate groups in mmol/g and the so-called equivalence weight in g/equivalent are reciprocal to each other. The content of isocyanate groups in mmol/g follows from the content in wt % to ASTM D-5155-96 A.

In a particularly preferred embodiment, component A) consists of at least one polyfunctional isocyanate selected from 4,4′-diphenylmethane diisocyanate, 2,4′-diphenylmethane diisocyanate, 2,2′-diphenylmethane diisocyanate and oligomeric diphenylmethane diisocyanate. In the context of this preferred embodiment, component (a1)) comprises oligomeric diphenylmethane diisocyanate, so-called “polymer-MDI”, with particular preference and has a functionality of at least 2.4.

The viscosity of component A) used can vary within wide limits. The viscosity of component A) is preferably in the range from 100 to 3000 mPa·s and more preferably in the range from 200 to 2500 mPa·s.

### Component C

It is also possible to co-use polyether polyols C) which are obtainable by known processes, for example by anionic polymerization of one or more alkylene oxides having 2 to 4 carbon atoms with alkali metal hydroxides, such as sodium hydroxide or potassium hydroxide, alkali metal alkoxides, such as sodium methoxide, sodium ethoxide, potassium ethoxide or potassium isopropoxide, or aminic alkoxylation catalysts such as dimethylethanolamine (DMEOA), imidazole and/or imidazole derivatives by using at least one starter molecule comprising from 2 to 8 and preferably from 2 to 6 reactive hydrogen atoms in bonded form, or by cationic polymerization with Lewis acids, such as antimony pentachloride, boron fluoride etherate or bleaching earth.

Suitable alkylene oxides are, for example, tetrahydrofuran, 1,3-propylene oxide, 1,2- or 2,3-butylene oxide, styrene oxide and preferably ethylene oxide and 1,2-propylene oxide. The alkylene oxides can be used individually, alternately in succession or as mixtures. Preferred alkylene oxides are propylene oxide and ethylene oxide, and ethylene oxide is particularly preferred.

Possible starter molecules are, for example: water, organic dicarboxylic acids, such as succinic acid, adipic acid, phthalic acid and terephthalic acid, aliphatic and aromatic, optionally N-monoalkyl-, N,N-dialkyl- and N,N′-dialkyl-substituted diamines having from 1 to 4 carbon atoms in the alkyl radical, e.g. optionally monoalkyl- and dialkyl-substituted ethylenediamine, diethylenetriamine, triethylenetetramine, 1,3-propylenediamine, 1,3- or 1,4-butylenediamine, 1,2-, 1,3-, 1,4-, 1,5- and 1,6-hexamethylenediamine, phenylenediamines, 2,3-, 2,4- and 2,6-tolylenediamine and 4,4′-, 2,4′- and 2,2′-diaminodiphenylmethane. Particular preference is given to the recited diprimary amines, for example ethylenediamine.

Further possible starter molecules are: alkanolamines such as ethanolamine, N-methylethanolamine and N-ethylethanolamine, dialkanolamines, such as diethanolamine, N-methyldiethanolamine and N-ethyldiethanolamine and trialkanolamines, such as triethanolamine, and ammonia.

Preference is given to using dihydric or polyhydric alcohols, such as ethanediol, 1,2- and 1,3-propanediol, diethylene glycol (DEG), dipropylene glycol, 1,4-butanediol, 1,6-hexanediol, glycerol, trimethylolpropane, pentaerythritol, sorbitol and sucrose.

The polyether polyols C), preferably polyoxypropylene polyols and polyoxyethylene polyols, more preferably polyoxyethylene polyols, have a functionality of preferably 2 to 6, more preferably of 2 to 4, especially of 2 to 3 and specifically 2 and number average molecular weights of 150 to 3000 g/mol, preferably 200 to 2000 g/mol and especially 250 to 1000 g/mol.

One preferred embodiment of the invention utilizes an alkoxylated diol, preferably an ethoxylated diol, for example ethoxylated ethylene glycol, as polyether polyol C); polyethylene glycol is preferably concerned.

In one advantageous embodiment of the invention, the polyetherol component C) consists exclusively of polyethylene glycol, preferably having a number average molecular weight of 250 to 1000 g/mol.

The proportion of polyether polyols C) is generally in the range from 0 to 11 wt %, preferably in the range from 2 to 9 wt % and more preferably in the range from 4 to 8 wt %, based on total components B) to G).

The mass ratio of component B) to component C), if present, is generally at least 1, preferably 3, more preferably 4, especially 5 and specifically 7.

The mass ratio of component B to component C), if present, is generally less than 80, preferably less than 40, more preferably less than 30, even more preferably less than 20, yet even more preferably less than 16 and specifically less than 13.

### Component D

Component D) is a flame-retardant mixture which is characterized by the fact that it consists d1) to an extent of at least 10 wt % and at most 90 wt %, based on the amount of flame-retardant mixture, of a flame retardant having a boiling point of not more than 220° C., and d2) to an extent of at least 10 wt % and at most 90 wt % of one or more phosphorus-containing flame retardants having a boiling point of greater than 220° C.

Useful flame retardants d1) include phosphates or phosphonates, for example diethyl ethanephosphonate (DEEP), triethyl phosphate (TEP) and dimethyl propylphosphonate (DMPP).

Useful flame retardants d2) include for example brominated esters, brominated ethers (Ixol) or brominated alcohols such as dibromoneopentyl alcohol, tribromoneopentyl alcohol, tetrabromophthalate diol (DP 54) and PHT-4-diol, and also chlorinated phosphates such as tris(2-chloroethyl)phosphate, tris(2-chloropropyl)phosphate (TCPP), tris(1,3-dichloropropyl)phosphate, tricresyl phosphate, diphenyl cresyl phosphate (DPK), tris(2,3-dibromopropyl)phosphate, tetrakis(2-chloroethyl)ethylenediphosphate, dimethyl methanephosphonate, diethyl diethanolaminomethylphosphonate and also commercially available halogenated flame-retardant polyols.

Useful flame retardants d1) having a boiling point below 220° C. have no isocyanate-reactive groups. The are preferably phosphorus-containing, more preferably halogen-free and more particularly selected from the group consisting of diethyl ethylphosphonate (DEEP) and triethyl phosphate (TEP) and dimethyl propylphosphonate (DMPP) and also mixtures thereof.

Preferred flame retardants d2), boiling above 220° C., have no isocyanate-reactive groups. The flame retardants are preferably liquid at room temperature, particularly preferred phosphorus-containing flame retardants are selected from the group consisting of tris(2-chloropropyl)phosphate (TCPP), diphenylcresyl phosphate (DPC); triphenyl phosphate (TPP) and also mixtures thereof. Halogen-free flame retardants are particularly preferable.

Preferably, component D) consists to an extent of from 10 to 70 wt % of one or more flame retardants d1) having a boiling point of not more than 220° C. and to an extent of from 30 to 90 wt % of one or more phosphorus-containing flame retardants d2) having a boiling point of greater than 220° C.

The proportion of flame-retardant mixture D) is generally in the range from 2 to 50 wt %, preferably in the range from 9 to 45 wt %, more preferably in the range from 15 to 36 wt % and even more preferably in the range from 20 to 30 wt %, based on total components B) to G).

### Component E

Further auxiliaries and/or addition agents E) can optionally be added to the reaction mixture for producing the rigid polyurethane foams. Mention may be made of, for example, surface-active substances, foam stabilizers, cell regulators, fillers, dyes, pigments, hydrolysis inhibitors, fungistatic and bacteriostatic substances.

Possible surface-active substances are, for example, compounds which serve to aid homogenization of the starting materials and may also be suitable for regulating the cell structure of the polymers. Mention may be made of, for example, emulsifiers such as the sodium salts of castor oil sulfates or of fatty acids and also salts of fatty acids with amines, e.g. diethylamine oleate, diethanolamine stearate, diethanolamine ricinoleate, salts of sulfonic acids, e.g. alkali metal or ammonium salts of dodecylbenzenesulfonic or dinaphthylmethanedisulfonic acid and ricinoleic acid; foam stabilizers such as siloxane-oxyalkylene copolymers and other organopolysiloxanes, ethoxylated alkylphenols, ethoxylated fatty alcohols, paraffin oils, castor oil esters or ricinoleic esters, Turkey red oil and peanut oil, and cell regulators such as paraffins, fatty alcohols and dimethylpolysiloxanes. The above-described oligomeric acrylates having polyoxyalkylene and fluoroalkane radicals as side groups are also suitable for improving the emulsifying action, the cell structure and/or for stabilizing the foam. The surface-active substances are typically employed in amounts of 0.01 to 10 parts by weight, based (i.e., reckoned) on 100 parts by weight of component B).

For the purposes of the present invention, fillers, in particular reinforcing fillers, are the customary organic and inorganic fillers, reinforcing materials, weighting agents, agents for improving the abrasion behavior in paints, coating compositions, etc., which are known per se Specific examples are: inorganic fillers such as siliceous minerals, for example sheet silicates such as antigorite, serpentine, hornblendes, amphiboles, chrisotile and talc, metal oxides such as kaolin, aluminum oxides, titanium oxides and iron oxides, metal salts, such as chalk, barite and inorganic pigments such as cadmium sulfide and zinc sulfide and also glass, etc. Preference is given to using kaolin (china clay), aluminum silicate and coprecipitates of barium sulfate and aluminum silicate and also natural and synthetic fibrous minerals such as wollastonite, metal fibers and in particular glass fibers of various lengths, which may be coated with a size. Possible organic fillers are, for example: carbon, melamine, rosin, cyclopentadienyl resins and graft polymers and also cellulose fibers, polyamide, polyacrylonitrile, polyurethane, polyester fibers based on aromatic and/or aliphatic dicarboxylic esters and in particular carbon fibers.

The inorganic and organic fillers can be used individually or as mixtures and are advantageously added to the reaction mixture in amounts of from 0.5 to 50 wt %, preferably from 1 to 40 wt %, based on the weight of the components A) to G), although the content of mats, nonwovens and woven fabrics of natural and synthetic fibers can reach values of up to 80 wt %, based on the weight of components A) to G).

Further information regarding the abovementioned other customary auxiliary and addition agents may be found in the technical literature, for example the monograph by J. H. Saunders and K. C. Frisch “High Polymers” Volume XVI, Polyurethanes, Parts 1 and 2, Interscience Publishers 1962 and 1964, or Kunststoff-Handbuch, Polyurethane, Volume VII, Hanser-Verlag, Munich, Vienna, 1st and 2nd Editions, 1966 and 1983.

### Component F

Blowing agents F) which are used for producing the rigid polyurethane foams include preferably water, formic acid and mixtures thereof. These react with isocyanate groups to form carbon dioxide and in the case of formic acid to form carbon dioxide and carbon monoxide. Since these blowing agents release the gas through a chemical reaction with the isocyanate groups, they are referred to as chemical blowing agents. In addition, physical blowing agents such as low-boiling hydrocarbons can be used. Suitable physical blowing agents are in particular liquids which are inert towards the polyisocyanates A) and have boiling points below 100° C., preferably below 50° C., at atmospheric pressure, so that they vaporize under the conditions of the exothermic polyaddition reaction. Examples of such liquids which are preferably used are alkanes such as heptane, hexane, n-pentane and isopentane, preferably industrial mixtures of n-pentane and isopentane, n-butane and isobutane and propane, cycloalkanes such as cyclopentane and/or cyclohexane, ethers such as furan, dimethyl ether and diethyl ether, ketones such as acetone and methyl ethyl ketone, alkyl carboxylates such as methyl formate, dimethyl oxalate and ethyl acetate and halogenated hydrocarbons such as methylene chloride, dichloromonofluoromethane, difluoromethane, trifluoromethane, difluoroethane, tetrafluoroethane, chlorodifluoroethanes, 1,1-dichloro-2,2,2-trifluoroethane, 2,2-dichloro-2-fluoroethane and heptafluoropropane. Mixtures of these low-boiling liquids with one another and/or with other substituted or unsubstituted hydrocarbons can also be used. Organic carboxylic acids such as formic acid, acetic acid, oxalic acid, ricinoleic acid and carboxyl-containing compounds are also suitable.

It is preferable not to use any halogenated hydrocarbons as blowing agents. Water, formic acid-water mixtures or formic acid are preferably used as chemical blowing agents with formic acid-water mixtures or formic acid being particularly preferred chemical blowing agents. It is preferable to use pentane isomers, or mixtures of pentane isomers, as physical blowing agents.

The chemical blowing agents can be used alone, i.e., without addition of physical blowing agents, or together with physical blowing agents. The chemical blowing agents are preferably used together with physical blowing agents, in which case the use of formic acid-water mixtures or pure formic acid together with pentane isomers or mixtures of pentane isomers is preferred.

The blowing agents are either wholly or partly dissolved in the polyol component (i.e. B+C+D+E+F+G) or are introduced via a static mixer immediately before foaming of the polyol component. It is usual for water, formic acid-water mixtures or formic acid to be fully or partially dissolved in the polyol component and the physical blowing agent (for example pentane) and any remainder of the chemical blowing agent to be introduced “on-line”.

The polyol component is admixed in situ with pentane, possibly some of the chemical blowing agent and also with all or some of the catalyst. Auxiliary and addition agents as well as flame retardants are already comprised in the polyol blend.

The amount of blowing agent or blowing agent mixture used is in the range from 1 to 45 wt %, preferably in the range from 1 to 30 wt % and more preferably in the range from 1.5 to 20 wt %, all based on total components B) to G).

When water, formic acid or a formic acid-water mixture is used as blowing agent, it is preferably added to the polyol component (B+C+D+E+F+G) in an amount of 0.2 to 10 wt %, based on component B). The addition of water, formic acid or formic acid-water mixture can take place in combination with the use of other blowing agents described. Preference is given to using formic acid or a formic acid-water mixture in combination with pentane.

### Component G

Catalysts G) used for preparing the rigid polyurethane foams are particularly compounds which substantially speed the reaction of the components' B) to G) compounds comprising reactive hydrogen atoms, especially hydroxyl groups, with the polyisocyanates A).

It is advantageous to use basic polyurethane catalysts, for example tertiary amines such as triethylamine, tributylamine, dimethylbenzylamine, dicyclohexylmethylamine, dimethylcyclohexylamine, N,N,N′,N′-tetramethyldiaminodiethyl ether, bis(dimethylaminopropyl)urea, N-methylmorpholine or N-ethylmorpholine, N-cyclohexylmorpholine, N,N,N′,N′-tetramethylethylenediamine, N,N,N,N-tetramethylbutanediamine, N,N,N,N-tetramethylhexane-1,6-diamine, pentamethyldiethylenetriamine, bis(2-dimethylaminoethyl)ether, dimethylpiperazine, N-dimethylaminoethylpiperidine, 1,2-dimethylimidazole, 1-azabicyclo-[2.2.0]octane, 1,4-diazabicyclo[2.2.2]octane (Dabco) and alkanolamine compounds, such as triethanolamine, triisopropanolamine, N-methyldiethanolamine and N-ethyldiethanolamine, dimethylaminoethanol, 2-(N,N-dimethylaminoethoxy)ethanol, N,N′,N″-tris(dialkylaminoalkyl)hexahydrotriazines, e.g. N,N′,N″-tris(dimethylaminopropyl)-s-hexahydrotriazine, and triethylenediamine. However, metal salts such as iron(II) chloride, zinc chloride, lead octoate and preferably tin salts such as tin dioctoate, tin diethylhexoate and dibutyltin dilaurate and also, in particular, mixtures of tertiary amines and organic tin salts are also suitable.

Further possible catalysts are: amidines such as 2,3-dimethyl-3,4,5,6-tetrahydropyrimidine, tetraalkylammonium hydroxides such as tetramethylammonium hydroxide, alkali metal hydroxides such as sodium hydroxide and alkali metal alkoxides such as sodium methoxide and potassium isopropoxide, alkali metal carboxylates and also alkali metal salts of long-chain fatty acids having from 10 to 20 carbon atoms and optionally lateral OH groups. Preference is given to using from 0.001 to 10 parts by weight of catalyst or catalyst combination, based (i.e., reckoned) on 100 parts by weight of component B). It is also possible to allow the reactions to proceed without catalysis. In this case, the catalytic activity of amine-initiated polyols is exploited.

When, during foaming, a relatively large polyisocyanate excess is used, further suitable catalysts for the trimerization reaction of the excess NCO groups with one another are: catalysts which form isocyanurate groups, for example ammonium ion salts or alkali metal salts, specifically ammonium or alkali metal carboxylates, alone or in combination with tertiary amines. Isocyanurate formation leads to flame-resistant PIR foams which are preferably used in industrial rigid foam, for example in building and construction as insulation boards or sandwich elements.

Further information regarding the abovementioned and further starting materials may be found in the technical literature, for example Kunststoffhandbuch, Volume VII, Polyurethane, Carl Hanser Verlag Munich, Vienna, 1st, 2nd and 3rd Editions 1966, 1983 and 1993.

The present invention also provides a polyol component for producing rigid polyurethane foams comprising the components B) to G) as described above. The mass ratio of component B) to component C) is preferably at least 1.

It is preferable for the polyol component to comprise

10 to 90 wt % of polyester polyols B),
0 to 11 wt % of polyether polyols C),
2 to 50 wt % of flame retardants D),
0.5 to 20 wt % of further auxiliary and addition agents E),
1 to 45 wt % of blowing agents F), and
0.5 to 10 wt % of catalysts G),
each as defined above and each based on the total weight of components B) to G), wherein components B) to G) total 100 wt %, and wherein the mass ratio of component B) to component C) is at least 4.

It is particularly preferable for the polyol component to comprise

40 to 90 wt % of polyester polyols B),
2 to 9 wt % of polyether polyols C),
9 to 45 wt % of flame retardants D),
0.5 to 20 wt % of further auxiliary and addition agents E),
1 to 30 wt % of blowing agents F),
0.5 to 10 wt % of catalysts G), and
each as defined above and each based on the total weight of components B) to G), wherein components B) to G) total 100 wt %, and wherein the mass ratio of component B) to component C) is at least 5.

The mass ratio of component B) to component C) in the polyol components of the present invention that is in accordance with the present invention is preferably less than 80, more preferably less than 40, even more preferably less than 30, yet even more preferably less than 20, yet still even more preferably less than 16 and specifically less than 13.

The mass ratio of the present invention for component A to the sum total B) to E) is further not less than 1.3, preferably not less than 1.5, more preferably not less than 1.7, even more preferably not less than 1.8, yet even more preferably not less than 2.0 and specifically not less than 2.5.

To produce the rigid polyurethane foams of the present invention, the optionally modified organic polyisocyanates A), the polyester polyols B), optionally the polyetherols C) and the further components D) to G) are mixed in such amounts that the equivalence ratio of NCO groups on polyisocyanates A) to total reactive hydrogen atoms on components B) and also D) to G) is in the range from 1 to 6:1, preferably in the range from 1.6 to 5:1 and especially in the range from 2.5 to 3.5:1.

The invention also provides the rigid polyurethane foams themselves and also their use for production of sandwich elements having rigid or flexible outer layers. These sandwich elements can be produced in a batch or continuous process with a continuous process being preferred.

The examples which follow illustrate the invention.

### EXAMPLES

The following polyester polyols (polyesterol 1, polyesterol 2) were used:

### Polyesterol 1:

Esterification product of phthalic anhydride (25 mol %), oleic acid (15 mol %), diethylene glycol (37 mol %) and a polyether (23 mol %) based on trimethylolpropane and ethylene oxide with an OH functionality of 3 and a hydroxyl number of 610 mg KOH/g, prepared in the presence of imidazole as alkoxylation catalyst and using the polyether without workup. The polyesterol has a hydroxyl functionality of 2.2, a hydroxyl number of 244 mg KOH/g and an oleic acid content of 24 wt % in the polyesterol.

### Polyesterol 2:

Esterification product of phthalic anhydride (30 mol %), oleic acid (12 mol %), diethylene glycol (40 mol %) and trimethylolpropane (18 mol %) with a hydroxyl functionality of 2.2, a hydroxyl number of 249 mg KOH/g and an oleic acid content of 25 wt % in the polyesterol.

The following were used as flame retardants:

trischloroisopropyl phosphate (TCPP) with a boiling point of 244° C., and
triethyl phosphate (TEP) with a boiling point of 215° C.

### Determination of Curing and Brittleness of Rigid Polyurethane Foam

Curing was determined using the bolt test. For this, at 2.5, 3, 4 and 5 minutes after mixing the components of the polyurethane foam in a polystyrene beaker, a steel bolt with spherical cap 10 mm in radius was pressed by tensile/compressive tester 10 mm deep into the mushroom-shaped foam formed. The maximum force in N required for this is a measure of the curing of the foam.

Brittleness was determined for the rigid polyisocyanurate foam directly after foaming in a subjective manner by compressing the foam and graded on a scale from 1 to 7, where 1 denotes a scarcely brittle foam and 7 denotes a foam of high brittleness. Brittleness was further classified by determining the time at which the surface of the rigid foam displayed visible zones of breakage in the bolt test.

### Determining the Self-Reactivity of Polyurethane Systems

The polyurethane systems described hereinbelow were adjusted to a unitary fiber time by varying the polyurethane catalyst concentration. When a system needed a lower concentration of catalyst, this was taken to mean that the system had higher self-reactivity.

### Comparative Examples 1 and 2 and Inventive Examples 1 and 2

### Production of Rigid Polyurethane Foams

The isocyanates and the isocyanate-reactive components were foamed up together with the blowing agents, catalysts and all further addition agents at a constant mixing ratio of 100:250 for polyol component to isocyanate.

### Comparative Example 1

Starting from

43.9 parts by weight of polyesterol 2 with a hydroxyl number of 244 mg KOH/g, based on the esterification product of phthalic anhydride, oleic acid, diethylene glycol and a polyether based on trimethylolpropane and ethylene oxide,
8 parts by weight of a polyetherol from ethoxylated ethylene glycol with a hydroxyl functionality of 2 and a hydroxyl number of 190 mg KOH/g,
43 parts by weight of trischloroisopropyl phosphate (TCPP) flame retardant, and
3.1 parts by weight of an 85% formic acid solution with water, and
2 parts by weight of silicone-containing foam stabilizer (Tegostab® B8467 from Evonik) a polyol component was produced by mixing.

The polyol component was reacted with 250 parts by weight of polymer MDI having an NCO content of 31.5 wt % (Lupranat® M50 from BASF SE, viscosity about 500 mPas at 25° C.) in the presence of n-pentane (16 parts by weight), a 70% bis-2-dimethylaminoethyl ether solution in dipropylene glycol (Niax® A1 from Momentive/designated catalyst 1 in table 1) and 2.6 wt % of a 36% potassium formate solution in monoethylene glycol. The components were intensively mixed using a laboratory stirrer. The amount of 70% bis-2-dimethylaminoethyl ether solution in dipropylene glycol (Niax® A1 from Momentive) was chosen such that the fiber time was 51 seconds. The resulting foam had a density of 33 kg/m³.

### Comparative Example 2

Starting from

43.9 parts by weight of polyesterol 1 with a hydroxyl number of 249 mg KOH/g, based on the esterification product of phthalic anhydride, oleic acid, diethylene glycol trimethylolpropane
8 parts by weight of a polyetherol from ethoxylated ethylene glycol with a hydroxyl functionality of 2 and a hydroxyl number of 190 mg KOH/g,
43 parts by weight of trischloroisopropyl phosphate (TCPP) flame retardant, and
3.1 parts by weight of an 85% formic acid solution with water, and
2 parts by weight of silicone-containing foam stabilizer (Tegostab® B8467 from Evonik) a polyol component was produced by mixing.

The polyol component was reacted with 250 parts by weight of polymer MDI having an NCO content of 31.5 wt % (Lupranat® M50 from BASF SE, viscosity about 500 mPas at 25° C.) in the presence of n-pentane (16 parts by weight), a 70% bis-2-dimethylaminoethyl ether solution in dipropylene glycol (Niax® A1 from Momentive/designated catalyst 1 in table 1) and 2.6 wt % of a 36% potassium formate solution in monoethylene glycol. The components were intensively mixed using a laboratory stirrer. The amount of 70% bis-2-dimethylaminoethyl ether solution in dipropylene glycol (Niax® A1 from Momentive) was chosen such that the fiber time was 51 seconds. The resulting foam had a density of 33 kg/m³.

### Inventive Example 1

Starting from

43.9 parts by weight of polyesterol 2 with a hydroxyl number of 249 mg KOH/g, based on the esterification product of phthalic anhydride, oleic acid, diethylene glycol and trimethylolpropane,
8 parts by weight of a polyetherol from ethoxylated ethylene glycol with a hydroxyl functionality of 2 and a hydroxyl number of 190 mg KOH/g,
25 parts by weight of trischloroisopropyl phosphate (TCPP) flame retardant, and
18 parts by weight of triethyl phosphate (TEP) flame retardant, and
3.1 parts by weight of an 85% formic acid solution with water, and
2 parts by weight of silicone-containing foam stabilizer (Tegostab® B8467 from Evonik) a polyol component was produced by mixing.

The polyol component was reacted with 250 parts by weight of polymer MDI having an NCO content of 31.5 wt % (Lupranat® M50 from BASF SE, viscosity about 500 mPas at 25° C.) in the presence of n-pentane (16 parts by weight), a 70% bis-2-dimethylaminoethyl ether solution in dipropylene glycol (Niax® A1 from Momentive/designated catalyst 1 in table 1) and 2.6 wt % of a 36% potassium formate solution in monoethylene glycol. The components were intensively mixed using a laboratory stirrer. The amount of 70% bis-2-dimethylaminoethyl ether solution in dipropylene glycol (Niax® A1 from Momentive) was chosen such that the fiber time was 51 seconds. The resulting foam had a density of 33 kg/m³.

### Inventive Example 2

Starting from

43.9 parts by weight of polyesterol 1 with a hydroxyl number of 244 mg KOH/g, based on the esterification product of phthalic anhydride, oleic acid, diethylene glycol and a polyether based on trimethylolpropane and ethylene oxide,
8 parts by weight of a polyetherol from ethoxylated ethylene glycol with a hydroxyl functionality of 2 and a hydroxyl number of 190 mg KOH/g,
25 parts by weight of trischloroisopropyl phosphate (TCPP) flame retardant, and
18 parts by weight of triethyl phosphate (TEP) flame retardant, and
3.1 parts by weight of an 85% formic acid solution with water, and
2 parts by weight of silicone-containing foam stabilizer (Tegostab® B8467 from Evonik) a polyol component was produced by mixing.

The polyol component was reacted with 250 parts by weight of polymer MDI having an NCO content of 31.5 wt % (Lupranat® M50 from BASF SE, viscosity about 500 mPas at 25° C.) in the presence of n-pentane (16 parts by weight), a 70% bis-2-dimethylaminoethyl ether solution in dipropylene glycol (Niax® A1 from Momentive/designated catalyst 1 in table 1) and 2.6 wt % of a 36 wt % potassium formate solution in monoethylene glycol. The components were intensively mixed using a laboratory stirrer. The amount of 70% bis-2-dimethylaminoethyl ether solution in dipropylene glycol (Niax® A1 from Momentive) was chosen such that the fiber time was 51 seconds. The resulting foam had a density of 33 kg/m³.

The results are summarized in table 1.

TABLE 1

| | Comparative | Comparative | Inventive | Inventive |
|---|---|---|---|---|
| | example 1 | example 2 | example 1 | example 2 |
| curing [N] | | | | |
| 2.5 min | 47 | 50 | 52 | 62 |
| 3 min | 54 | 58 | 63 | 73 |
| 4 min | 71 | 70 | 80 | 85 |
| 5 min | 75 | 65 | 89 | 86 |
| total (2.5, 3, 4 and 5 | 247 | 243 | 284 | 306 |
| min) | | | | |
| subjective brittleness | 7 | 7 | 6 | 3 |
| breakage in bolt test | 4 | 4 | 4 | 6 |
| catalyst 1 | 2.6 | 2.1 | 1.4 | 1.0 |
| viscosity of polyol | 618 | 297 | 182 | 106 |
| component at | | | | |
| T = 20° C. | | | | |

It is clearly apparent that the inventive polyol components increase the self-reactivity of the system. Inventive examples 1 and 2 only need 1.0 part by weight and 1.4 parts by weight of catalyst 1 respectively compared with 2.1 and 2.6 parts by weight respectively in comparative examples 1 and 2.

The inventive polyol components also lead to improved curing of the foam. The sum total for the measurements at 2.5 min, 3 min, 4 min and 5 min is 306 N or, respectively, 284 N and hence is distinctly above the results of the comparative examples, which have values of 247 N and 243 N respectively.

The invention further serves to reduce the viscosity of the polyol components from 618 and 297 mPas at 20° C. to 182 and 106 mPas at 20° C. respectively. This leads to better miscibility of the polyol component with the isocyanate. This reduces the frequency of surface defects and results in an improved foam surface.

The inventive polyol components also reduced the brittleness of the insulant and hence the dusting and cracking tendency on sawing composite elements having a polyisocyanurate foam core. Brittleness decreases both measured subjectively using finger pressure on the foam after foaming and measured in terms of breakage time in the curing measurement.

We claim:

1. A process for producing rigid polyurethane foams by reaction of
A) one or more organic polyisocyanates,
B) one or more polyester polyols,
C) optionally one or more polyether polyols,
D) a flame-retardant mixture,
E) further auxiliaries or addition agents,
F) one or more blowing agents, and also
G) catalysts,
wherein said flame-retardant mixture D) comprises
d1) 10 to 90 wt %, based on the amount of flame-retardant mixture, of a flame retardant having a boiling point of not more than 220° C., and
d2) 10 to 90 wt %, based on the amount of flame-retardant mixture, of a phosphorus-containing flame retardant having a boiling point of above 220° C.,
wherein said components d1) and d2) total 100 wt %.

2. The process according to claim 1 wherein said flame retardant d1) having a boiling point of not more than 220° C. is selected from the group consisting of diethyl ethylphosphonate (DEEP), triethyl phosphate (TEP), dimethyl propylphosphonate (DMPP) and mixtures thereof.

3. The process according to claim 1 wherein said flame retardant d2) having a boiling point of above 220° C. is selected from the group consisting of tris(2-chloropropyl) phosphate (TCPP), diphenyl cresyl phosphate (DPC), triphenyl phosphate (TPP) and mixtures thereof.

4. The process according to claim 1 wherein said polyester polyol B) comprises at least one polyetherester polyol comprising the esterification product of
b1) 10 to 70 mol % of a dicarboxylic acid composition comprising
b11) 50 to 100 mol %, based on the dicarboxylic acid composition, of one or more aromatic dicarboxylic acids or derivatives thereof,
b12) 0 to 50 mol %, based on said dicarboxylic acid composition b1), of one or more aliphatic dicarboxylic acids or derivatives thereof,
b2) 2 to 30 mol % of one or more fatty acids or fatty acid derivatives,
b3) 10 to 70 mol % of one or more aliphatic or cycloaliphatic diols having 2 to 18 carbon atoms or alkoxylates thereof,
b4) 2 to 50 mol % of a polyether polyol having a functionality of not less than 2, prepared by alkoxylating a polyol having a functionality of not less than 2,
all based on the total amount of components b1) to b4), wherein said components b1) to b4) sum to 100 mol %.

5. The process according to claim 4 wherein said polyester polyol B) consists exclusively of one or more polyetherester polyols as defined in claim 4.

6. The process according to claim 4 wherein said polyether polyol b4) has a functionality of >2.

7. The process according to claim 4 wherein said polyether polyol b4) is prepared by alkoxylating a polyol selected from the group consisting of sorbitol, pentaerythritol, trimethylolpropane, glycerol, polyglycerol and mixtures thereof.

8. The process according to claim 4 wherein said polyether polyol b4) is produced by alkoxylation with ethylene oxide.

9. The process according to claim 4 wherein said component b11) comprises one or more compounds selected from the group consisting of terephthalic acid, dimethyl terephthalate, polyethylene terephthalate, phthalic acid, phthalic anhydride and isopththalic acid.

10. The process according to claim 4 wherein said dicarboxylic acid composition b1) comprises no aliphatic dicarboxylic acids b12).

11. The process according to claim 4 wherein said fatty acid or fatty acid derivative b2) is selected from the group consisting of castor oil, polyhydroxy fatty acids, ricinoleic acid, hydroxyl-modified oils, grapeseed oil, black cumin oil, pumpkin kernel oil, borage seed oil, soybean oil, wheat germ oil, rapeseed oil, sunflower oil, peanut oil, apricot kernel oil, pistachio oil, almond oil, olive oil, macadamia nut oil, avocado oil, sea buckthorn oil, sesame oil, hemp oil, hazelnut oil, primula oil, wild rose oil, safflower oil, walnut oil and fatty acids, hydroxyl-modified fatty acids and fatty acid esters based on myristoleic acid, palmitoleic acid, oleic acid, vaccenic acid, petroselic acid, gadoleic acid, erucic acid, nervonic acid, linoleic acid, α- and γ-linolenic acid, stearidonic acid, arachidonic acid, timnodonic acid, clupanodonic acid and cervonic acid.

12. The process according to claim 11 wherein said fatty acid or fatty acid derivative b2) is selected from the group consisting of oleic acid and methyl oleate.

13. The process according to claim 4 wherein said aliphatic or cycloaliphatic diols b3) are selected from the group consisting of ethylene glycol, diethylene glycol, propylene glycol, 1,3-propanediol, 1,4-butanediol, 1,5-pentanediol, 1,6-hexanediol, 2-methyl-1,3-propanediol and 3-methyl-1,5-pentanediol and alkoxylates thereof.

14. The process according to claim 1 wherein said polyether polyols C) are selected from the group consisting of polyoxypropylene polyols and polyoxyethylene polyols.

15. The process according to claim 1 wherein polyether polyol C) utilizes exclusively polyethylene glycol.

16. The process according to claim 1 wherein the mass ratio of component A) to the sum total of B) to E) is not less than 1.3.

17. A rigid polyurethane foam obtainable by the process according to claim 1.

18. A polyol component for producing rigid polyurethane foams comprising said components B) to G) as defined in claim 1, wherein the mass ratio of component B) to component C) is at least 1.
